(19) United States
(12) Patent Application Publication
(10) Pub. No.: US 2004/0128802 A1
(43) Pub. Date: Jul. 8, 2004

(54) Webbing tie down assembly

(76) Inventor: John Templeton, East Sussex (GB)

Correspondence Address: Arlene J. Powers, Gauthier & Connors LLP, Suite 3300, 225 Franklin Street, Boston, MA, 02110, US

(21) Appl. No.: 10/729,524

(22) Filed: Dec. 5, 2003

Related U.S. Application Data
(63) Continuation-in-part of application No. 09/857,937, filed on Aug. 2, 2001, now abandoned.

(51) Int. Cl. B25B 25/00

(52) U.S. Cl. 24/68 CD

(57) ABSTRACT

A webbing tie down assembly, comprising a clamping mechanism comprising: a first clamping member (309) having a first clamping surface (320), and a second clamping member. (307) having a second clamping surface, the two members being moveable to a clamping position in which the clamping surfaces are substantially together for clamping webbing therebetween, webbing under tension passing around the outer surface of the first clamping member and thence between the clamping surfaces to be clamped to the clamping mechanism, said second clamping member comprises a shaft, and the clamping surface (320) of the first clamping member has a complementary curvature, so that the clamping surfaces of the first and second clamping members lie substantially parallel in the clamping position so that a clamping force on the webbing is distributed over a relatively large surface area of the webbing, and successive parts (309a, 309b, 309c, 320) of the outer surface of the first clamping member smoothly merge into one another without any abrupt change of direction so that the webbing is not distorted.

### REFERENCE TO RELATED APPLICATIONS

This application is a Continuation-in-Part of U.S. Ser. No. 09/857,937 filed Aug. 2, 2001.

### BACKGROUND OF THE INVENTION

The present invention relates to a webbing tie down assembly or lashing restraint, having a clamping mechanism for securely clamping a webbing tie or lashing.

A webbing tie down assembly is provided in circumstances where webbing is used, for example, to tie down an object to a base, whereby the webbing can withstand applied loads arising from relative movement between the object and the base.

For instance, a plurality of webbing ties are used to secure a helicopter to the deck of a ship. Each webbing tie (or lashing) is fitted at one end to a fitting on the deck of the ship and at the other end is clamped and tensioned within a tie down assembly which is hooked onto a fitting of a helicopter.

A known webbing tie down assembly is shown in FIGS. 1A and 1B. The device comprises a hook, for fastening over a helicopter fitting, and a clamping and tensioning mechanism for a webbing tie. One end of the webbing tie is secured to a deck fitting, and the other free end is received within the clamping mechanism of the assembly as shown in FIGS. 1A and 1B. When the clamping mechanism is closed, a portion of the webbing is clamped between a roller shaft on one side and a clamping surface on the other side having a notch therein for gripping the webbing. Tensioning of the webbing is achieved by pulling on the free end of the webbing, as described in more detail below.

Although the existing webbing tie down assembly provides a combined clamping and tensioning mechanism, which is compact, lightweight, easy and convenient to use on the deck of a ship, it cannot sustain loads exceeding 5000 lbs. Thus, even the use of about 20 webbing ties for an individual helicopter is insufficient to permanently secure it to the deck of a ship. Instead, heavy chains are used, to replace the temporary webbing ties, to ensure that a helicopter is safely secured to the deck of a ship.

U.S. Pat. No. 3,099,055 discloses a strap-tensioning device for securing cargo in position. This discloses a clamping mechanism which comprises a first clamping member in the form of a flat beam 23 and a second clamping member in the form of a cylindrical beam 18, the two beams being moveable to a clamping position in which their clamping surfaces clamp webbing therebetween. The second member or beam 18 is in the form of a shaft and the first clamping member of beam 23 is in the form of a flat beam. The surface between which the webbing is clamped is therefore a narrow surface which extends along the lengths of the beams 23, 18 which can potentially have a damaging effect on the webbing.

U.S. Pat. No. 2,079,457 discloses a device for taking blood pressure in which a strap is clamped around the clamping members 19, 12, the clamping member 12 being of generally circular cross section and the clamping member 19 being of a meniscus shape. The difficulty with the meniscus shape is that the opposite ends of the cross section of the meniscus shaped clamping member 19 are quite sharp and if substantial force is applied to the webbing, then the webbing will be damaged. In the example of a device for taking blood pressure, the strap 25 is likely to be very flexible and not much tension is applied to it. However using the same technique to lash down a helicopter would damage the webbing.

### SUMMARY OF THE INVENTION

The present invention aims to provide a webbing tie down assembly which achieves simple clamping and tensioning of the webbing, which can sustain increased loads compared with the prior art preferably enabling webbing ties to be used to permanently secure a helicopter to the deck of a ship, thereby obviating the need for securing chains.

In a first aspect, the present invention provides a webbing tie down assembly, comprising:

a clamping mechanism comprising: a first clamping member having a first clamping surface, and a second clamping member having a second clamping surface, the two members being moveable to a clamping position in which the clamping surfaces are substantially together for clamping webbing therebetween, webbing under tension passing around the outer surface of the first clamping member and thence between the clamping surfaces to be clamped to the clamping mechanism, said second clamping member comprises a shaft, and the clamping surface of the first clamping member has a complementary curvature, so that the clamping surfaces of the first and second clamping members lie substantially parallel in the clamping position so that a clamping force on the webbing is distributed over a relatively large surface area of the webbing, and successive parts of the outer surface of the first clamping member smoothly merge into one another without any abrupt change of direction so that the webbing is not distorted.

According to a second aspect, the present invention provides a webbing tie down assembly, comprising:

an inner frame and an outer frame, the inner frame and the outer frame being arranged to support webbing therein and including a clamping mechanism comprising: a first clamping member supported by the inner frame and having a first clamping surface, and a second clamping member supported by the outer frame and having a second clamping surface, the inner frame being mounted with respect to the outer frame for movement between a first position in which the first and second clamping surfaces are substantially together for clamping webbing therebetween, and a second position in which the clamping surfaces are apart for allowing webbing to slide there through; and further including a tensioning mechanism, for disengaging the first and second clamping surfaces when the inner frame and outer frame are in the first position to permit the webbing to slide therebetween to enable tensioning of the webbing, one of the first and second clamping members comprises a shaft, and the clamping surface of the other clamping member has a complementary curvature, so that the clamping surfaces of the first and second clamping members lie substantially parallel in the first position so that a clamping force on the webbing is distributed over a relatively large surface area of the webbing and successive parts of the outer surface of the first clamping member smoothly merge into one another without any abrupt change of direction so that the webbing is not distorted.

### BRIEF DESCRIPTION OF THE DRAWINGS

Embodiments of the present invention will now be described, by way of example, with reference to the accompanying drawings, in which:

FIG. 1A is a schematic side view of a prior art webbing tie down assembly;

FIG. 1B is a schematic plan view of the prior art webbing tie down assembly of FIG. 1A;

FIG. 2 is a schematic view showing the use of a webbing tie down assembly to secure a helicopter to the deck of a ship;

FIG. 3 is a side view of a webbing tie down assembly forming a preferred embodiment of the present invention;

FIG. 3a is an enlarged side view of the clamping mechanism of the webbing tie down assembly of FIG. 3;

FIG. 4 is a perspective view, partly cut away, of the webbing tie down assembly of FIG. 3; and

FIGS. 5A to C show the embodiment of FIG. 3 in different positions in use.

### DESCRIPTION OF THE PREFERRED EMBODIMENTS OF THE INVENTION

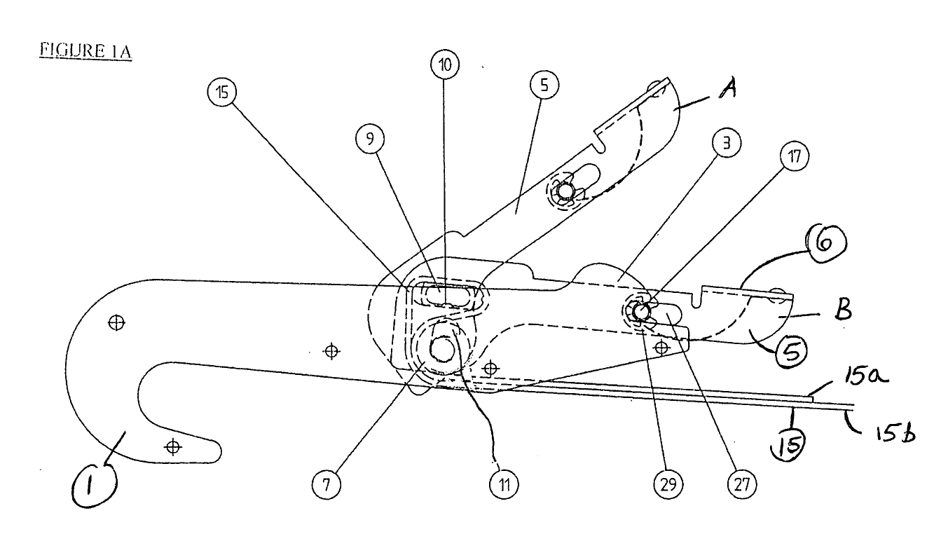

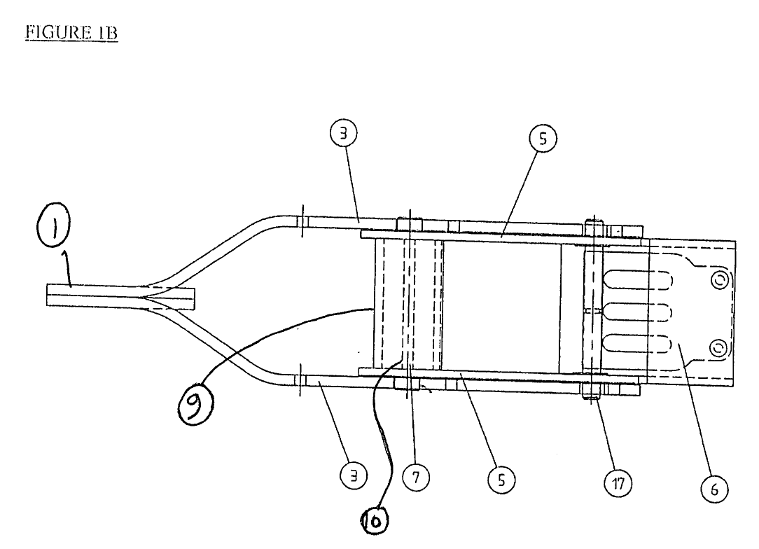

FIGS. 1A and 1B show a known webbing tie down assembly comprising a pair of longitudinally extending parallel outer plates 3 enclosing a pair of parallel inner plates 5 which are linked together at a rear end of the assembly by a transversely extending handle 6. The thus linked inner plates 5 are together pivotally mounted on a roller shaft 7 extending transversely between, and secured to, the outer plates 3 such that the inner plates 5 lie parallel to the outer plates 3 and can pivot with respect thereto by movement of the handle 6. A hook 1, for attachment to the fitting of, for example, a helicopter, is formed integrally with the outer plates 3 at a front end of the assembly.

An upper clamping member 9 is secured between the inner plates 5 above the roller shaft 7 and has a notch 10 in a surface thereof opposing the surface of the roller shaft 7. The roller shaft 7 is mounted to the outer plates 3 through respective vertically extending slots 11 in the inner plates such that the roller shaft 7 can be displaced relative to the clamping member 9 by movement upwardly and downwardly within the slots 11.

Webbing 15 is passed into the assembly from the rear end, opposite to the front end which secures the hook 1, looped around the front of roller shaft 7, passed between the roller shaft 7 and clamping member 9, around the clamping member and returned out through the rear end of the assembly, as shown in FIG. 1A.

In use, the hook 1 is secured to the fastening of the helicopter and the inner plates 5 are moved from the open position ‘A’ shown in FIG. 1A to the closed position ‘B’ shown in in FIG. 1A. A transversely extending latching bar 17, extending between the inner plates 5 and retained within respective longitudinally extending slots 27 therein, is used to secure the inner plates 5 in the closed position with respect to the outer plates 3 by engagement with notches 29 in the outer plates 3.

In the closed position ‘B’, the webbing 15 is clamped between the notch 10 in the clamping member 9 and the surface of the roller 7. From the clamped position, tension can be applied to the webbing 15 by pulling on the free end 15a of the webbing. The pulling force is sufficient to displace the roller shaft 7 downwardly within the slots 11 in the inner plates 5, to remove the clamping force applied to the webbing and allow it to pass freely through the assembly between the clamping member 9 and the roller 7, without disengaging the latching bar 17 from the closed position. On the other hand, force applied to the other end 15b of the webbing by, for example, swaying movement of the helicopter, displaces the roller shaft 7 upwardly within the slots 11 in the inner plates 5, to increase the clamping force applied to the webbing and prevent movement through the assembly between the clamping member 9 and the roller 7.

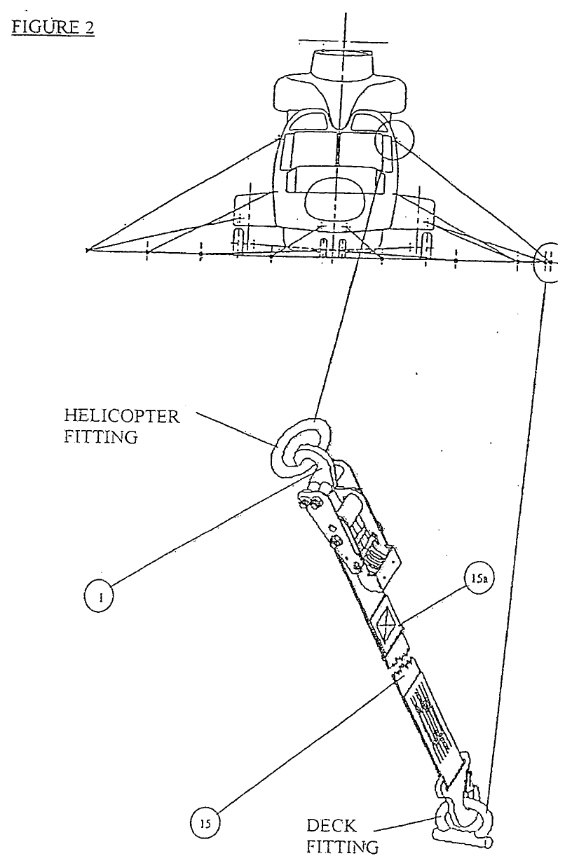

FIG. 2 illustrates one manner of use of the known webbing tie down assembly when securing a helicopter to the deck of a ship. This and other manners of use are possible with the webbing tie down assembly of the present invention.

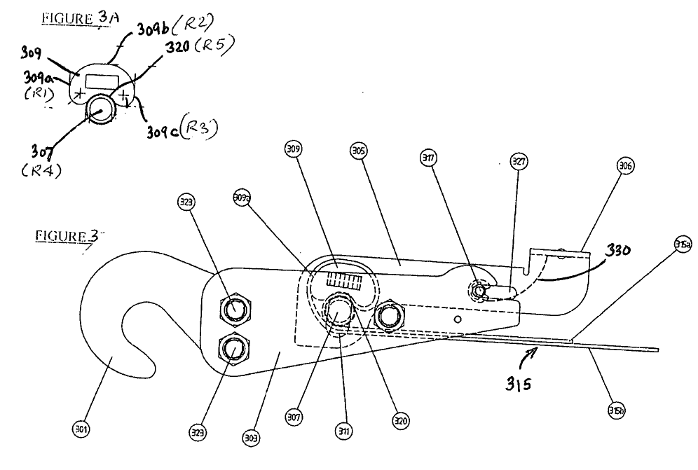

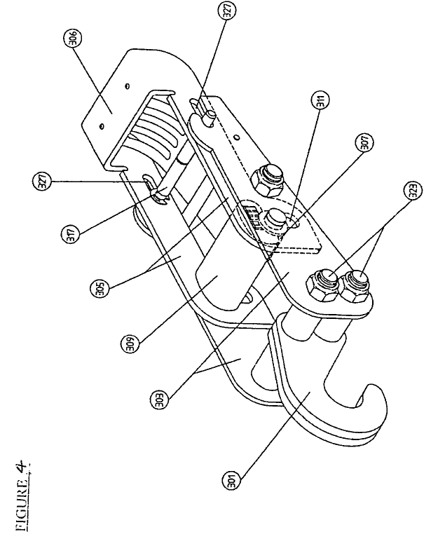

FIGS. 3 to 5 show a webbing tie down assembly according to a preferred embodiment of the present invention.

In particular, the assembly comprises a pair of parallel inner plates 305 which are linked together by a handle 306 and are together pivotally mounted on a roller shaft 307 secured between a pair of parallel outer plates 303. The shaft 307 extends through a slot 311 in each of the inner plates 305 and is rigidly mounted to the outer plates 303.

A pair of securing points 323 are provided on the outer plates at a front end of the assembly which mount a hook 301. The use of a pair of securing points prevents rotation of the hook relative to the outer plates 303.

A latching mechanism is provided to lock the inner plates 305 in the closed position relative to the outer plates 303. The latching mechanism comprises a latching bar 317 extending transversely between the inner plates 305 through longitudinally extending slots 327 in the inner plates 305 which cooperate with notches 329 in the outer plates 303 in the closed position. The latching bar 317 is biased by means of a leaf spring 330 towards the front end of the slots 327 for engagement with the notches 329 in the outer plates 303 but can be released from engagement by sliding the latching bar 317 rearwardly along the slots 327 against the biasing force.

The clamping mechanism of the preferred embodiment incorporates complementary curved clamping surfaces for clamping the webbing.

Referring to FIG. 3, the clamping mechanism comprises an upper clamping member 309 mounted between the inner plates 305, and the roller shaft 307 forms the lower clamping member. The shape of the upper clamping member 309 with respect to the roller shaft is particularly important for the clamping function and will be described in detail hereinafter, with reference to FIG. 3A.

The clamping surface 320 of the upper clamping member 309, which opposes the surface of roller shaft 307, is formed with a radius of curvature (R5) complementary to the radius of curvature (R4) of the shaft (R4=10.0 mm as seen from FIG. 3A) such that when webbing 315 is clamped between the clamping members 307, 309 the clamping surfaces 320, 307 lie substantially parallel, separated by a distance slightly less than the normal thickness of the webbing, thus applying a generally uniform clamping force over a large surface area of the webbing. It will be noted that the clamping surfaces have a generally large surface area for clamping a large surface area of the webbing to allow a large clamping force to be applied to the webbing without damaging it.

The remainder of the surface of the upper clamping member 309 is smoothly curved to allow the webbing 315 to slide around the clamping member without catching or tearing. It is particularly important that the curvature of the front end surface 309a of the upper clamping member 309 (where the part of the webbing 315b which carries the load first engages the upper clamping member 309) has a sufficiently large radius of curvature R1 at the point 309a in FIG. 3A to prevent undue bending and tension on the webbing which can lead to wear. Thus the part 315b of the webbing is smoothly guided from the roller shaft 307 to the point 309a without any abrupt change of direction. The minimum radius of curvature R1 at point 309a is 6.35 mm as illustrated in FIG. 3A.

The upper surface of the upper clamping member 309 then extends from the point 309a smoothly in an arc of an increasing radius to the uppermost point 309b (the radius increasing from R1=6.35 mm to R2=infinity, where R2 is the radius at uppermost point 309b) and then decreases symmetrically to a rearmost point 309c where the radius R3 is again 6.35 mm. From the points 309c and 309a the surface smoothly merges with the clamping surface 320 of the upper clamping member 309, which clamping surface has a reverse radius of curvature R5 (10.0 mm) equal to or close to the radius of curvature R4 of the roller shaft 307 to allow for the thickness of the webbing clamped therebetween.

Thus as is clear from FIGS. 3 and 3A, the successive parts of the outer surface of the upper clamping member smoothly merge into one another without any abrupt change of direction so that the webbing is not distorted and may easily flex around the upper clamping member 309. The minimum radius of curvature is 6.35 mm (although it is possible for it to be a little less, see below, say, 4 mm. This reduces damage to the webbing under tension. A plot of the radii of curvature around the upper clamping member would not include any discontinuities or abrupt changes.

Effectively it will be seen that the cross section of upper clamping member 307 is kidney shaped.

The exact dimensions of R1-R5 will depend upon the circumstances, particularly the loads involved and the thickness of the webbing. Thus in use for lashing helicopters, the ranges may be as follows:—

R1, 4 to 9 mm, preferably 5 to 8 mm, preferably 6.5 mm.

R2, infinity to 20 mm, preferably infinity to 100 mm, preferably infinity.

R3, 4 to 9 mm, preferably 5 to 8 mm, preferably 6.5 mm. (note, R3 does not need to be identical to R1.)

R4, 7 to 14 mm, preferably 8 to 12 mm, preferably 10 mm. (this must be chosen on the basis of R5 and the thickness of the webbing, or vice versa)

R5, 7 to 14 mm, preferably 8 to 12, preferably 10 mm.

It will be noted that the clamping surface 320 is of the opposite curvature to the other surfaces of the upper clamping member 309, which provides a serpentine path for the webbing and hence a locking action on the webbing preventing slipping.

It is also advantageous if the upper surface of the upper clamping member extends below the level of the inner plates 305, so that the inner plates act to guide the webbing 315 therebetween as it passes over the upper clamping member 309, without the risk of the webbing “riding up” and catching on one of the inner plates.

Webbing 315 is passed through the assembly as shown in FIG. 3. In particular, the free end 315a of the webbing 315 is inserted into the rear end of the assembly between the inner plates 305, passed beyond the front of the shaft 307 and then over upper clamping member 309 and rearwardly over the upper surface of the upper clamping member 309, then forwardly between the clamping surface 320 of the upper clamping member 309 and the roller shaft 307, around the front of the roller shaft 307 and then back out through the rear end of the assembly, as shown.

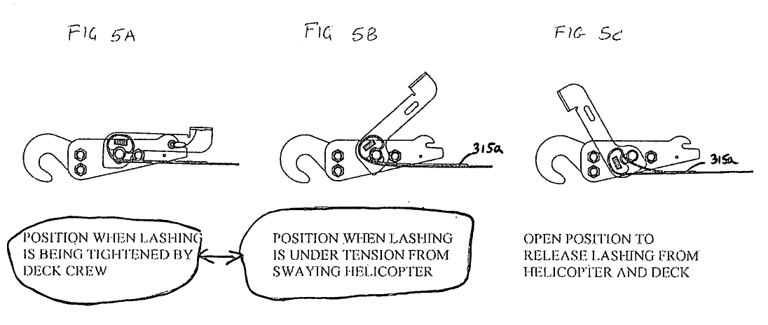

FIGS. 5A to C show the various positions of the preferred embodiment of the present invention, in use.

Referring to FIG. 5C, the latching bar 317 is disengaged from the notches 329 within the outer plates 303, so that the inner plates 305 can be pivoted about the roller shaft 307 by lifting of the handle 306 to the illustrated open position. In this position, the webbing 315 is neither clamped nor under tension, and is free to run around the pulley mechanism and between the clamping surfaces to enable the hook 301 to be released from, or secured to, for example, a helicopter fitting as shown in FIG. 2.

Once the hook 301 has been secured to the helicopter fitting, and whilst the handle is in the position of FIG. 5C or 5C it is necessary to pull taut the webbing 315 and this is achieved by simply pulling on the free end 315a as shown by the arrows in FIG. 5(c) to tension the webbing 315. The force applied to the free end 315a of the webbing exerts a force on the roller shaft 307, which displaces the roller shaft 307 downwardly (in FIG. 5B or to the left in FIG. 5C within the slots 311 in the inner plates 305. The ends of the roller shaft 307 are secured to the outer plates 303, which mount the lower clamping member 319b, so that the outer plates 303 and lower clamping member 319b are also displaced downwardly, thus disengaging the clamping surfaces of the upper and lower clamping members and permitting the webbing 315 to move therebetween. Thus, the webbing 315 can be pulled through the assembly to apply tension to the webbing 315 and thus remove any slack between deck and helicopter. The tension applied is limited to that which can be applied manually.

In the position of FIG. 5B, the upper clamping member 309 and the shaft 307 begin to clamp the webbing between them and as the inner plates are oed to the position of FIG. 5A the webbing 315b connected to the deck is tensioned by a predetermined amount owing to the “over entering” arrangement. This last movement uses the upper clamping member to pivot about the shaft 307 and pull on the webbing to stretch and tension it to a predetermined extent. This ensures that the webbing is tensioned but not overstretched.

The described embodiments of the present invention are designed for use with relatively thick polyester webbing having a breaking force in excess of 15000 lb. The thickness of the webbing is not however critical, and the webbing tie down assembly has been found to work effectively with a variety of webbing thicknesses.

It is anticipated that the webbing tie down assembly of the present invention can be used, in conjunction with webbing having the abovementioned breaking force, to permanently secure a helicopter to the deck of a ship, without the need for chains.

It will be appreciated that various modifications may be made to the described embodiments, to meet the working requirements including the thickness and material of the webbing, and the load which the assembly is designed to withstand. For instance, the skilled person will appreciate that the curvature of the upper clamping member of the preferred embodiment could be achieved using a pair of bolts, mounted parallel to each other, with the required radius of curvature.

The materials and gauge of the components of the assembly are chosen to be lighter in weight than the first embodiment, that is, components are formed from aluminium alloys wherever possible and narrower gauge components are employed. It will be appreciated that the assembly should be as light as possible for an individual to carry several at a time, whilst meeting the functional load-bearing requirements. Thus, the described assemblies need to balance the features of heavy and relatively thick hard drawn stainless steel shafts necessary to perform load bearing functions, and more lighter weight material.

In an alternative embodiment (not shown), the slots 311 extend in an arc generally centred about the axis of the latching bar 317. The arcuate curvature of slots 311, being generally centred about the axis of the latching bar 317, prevents the latching bar 317 from movement, arising during clamping and unclamping of the webbing, which can lead to wear in the region surrounding the notches which engage the bar 317. Instead, the roller shaft 307 can take up this movement, within the arcuate slots, so that the axis of the latching bar 317 remains stationary during tensioning of the webbing, thus preventing wear.

1. A webbing tie down assembly, comprising:
a clamping mechanism comprising: a first clamping member having a first clamping surface, and a second clamping member having a second clamping surface, the two members being moveable to a clamping position in which the clamping surfaces are substantially together for clamping webbing therebetween, webbing under tension passing around the outer surface of the first clamping member and thence between the clamping surfaces to be clamped to the clamping mechanism,
said second clamping member comprises a shaft, and the clamping surface of the first clamping member has a complementary curvature, so that the clamping surfaces of the first and second clamping members lie substantially parallel in the clamping position so that a clamping force on the webbing is distributed over a relatively large surface area of the webbing, and successive parts of the outer surface of the first clamping member smoothly merge into one another without any abrupt change of direction so that the webbing is not distorted.

2. A webbing tie down assembly as claimed in claim 1 in which the outer surface of the first clamping member is curved.

3. A webbing tie down assembly as claimed in claim 2 in which the minimum radius of curvature of the outer surface of the first clamping member is selected from 6.35 mm, 4 to 9 mm, 5 to 8 mm.

4. A webbing tie down assembly as claimed in claim 2 in which the first clamping member is kidney shaped in cross section, and the curvature of the front end surface of the first clamping member where the part of the webbing which carries the load first engages the first clamping member has a radius of curvature R1 selected from 6.35 mm, 4 to 9 mm, 5 to 8 mm.

5. A webbing tie down assembly as claimed in claim 4 in which the surface of the first clamping member extends from a forward point where the part of the webbing which carries the load first engages the first clamping member smoothly in an arc of an increasing radius to an uppermost point and then decreases symmetrically to a rearmost point where the radius R3 is selected from 6.35 mm, 4 to 9 mm, 5 to 8 mm and the surface smoothly merges from said forward and rearmost points with the clamping surface of the first clamping member.

6. A webbing tie down assembly as claimed in claim 1 in which the webbing follows a serpentine path between the clamping surfaces.

7. A webbing tie down assembly as claimed in claim 1 in which the two members are moveable to a second position in which the clamping surfaces are moved apart for allowing webbing to slide therebetween.

8. A webbing tie down assembly as claimed in claim 1, comprising an inner frame supporting said first clamping member and comprises a first pair of substantially parallel inner plates, and an outer frame supporting said second clamping member and comprises a second pair of substantially parallel outer plates, the assembly further comprising a roller shaft, wherein the first pair of substantially parallel inner plates is mounted on the roller shaft to pivot between the clamping and second positions, and wherein in the clamping position, the inner plates of the first frame lie between the outer plates of the second frame

9. A webbing tie down assembly as claimed in claim 8, further comprising a latching mechanism, for securing the inner plates with respect to the outer plates in the clamping position.

10. A webbing tie down assembly as claimed in claim 9, wherein the first pair of substantially parallel inner plates are linked together by a handle for movement between the clamping and second positions.

11. A webbing tie down assembly as claimed in claim 9, including a tensioning mechanism comprising a pair of slots in respective ones of either the first pair of substantially parallel inner plates or the second pair of substantially parallel outer plates, the roller shaft extending through the pair of slots and being rigidly mounted to the other of the first pair of substantially parallel inner plates or the second pair of substantially parallel outer plates, so that the inner frame can be displaced relative to the outer frame along the length of the slots.

12 A webbing tie down assembly as claimed in claim 1, in which the assembly has a first end and a second end, the first end carrying a hook for attachment to an object to be tied down, the hook being secured to the assembly at a pair of securing points.

13. A webbing tie down assembly as claimed in claim 12, in which the at least one supporting surface includes one or more pulley shafts arranged within the assembly to distribute the load of the webbing whilst spacing apart the surfaces thereof.

14. A webbing tie down assembly, comprising:
an inner frame and an outer frame, the inner frame and the outer frame being arranged to support webbing therein and including a clamping mechanism comprising: a first clamping member supported by the inner frame and having a first clamping surface, and a second clamping member supported by the outer frame and having a second clamping surface, the inner frame being mounted with respect to the outer frame for movement between a first position in which the first and second clamping surfaces are substantially together for clamping webbing therebetween, and a second position in which the clamping surfaces are apart for allowing webbing to slide there through; and further including a tensioning mechanism, for disengaging the first and second clamping surfaces when the inner frame and outer frame are in the first position to permit the webbing to slide therebetween to enable tensioning of the webbing,
one of the first and second clamping members comprises a shaft, and the clamping surface of the other clamping member has a complementary curvature, so that the clamping surfaces of the first and second clamping members lie substantially parallel in the first position so that a clamping force on the webbing is distributed over a relatively large surface area of the webbing and successive parts of the outer surface of the first clamping member smoothly merge into one another without any abrupt change of direction so that the webbing is not distorted.

15 A webbing tie down assembly as claimed in claim 14, in which at least one of the first and second clamping members has a supporting surface, substantially opposite the clamping surface, the supporting surface being arranged to support webbing.

16. A webbing tie down assembly as claimed in claim 15, in which the or each supporting surface is smoothly curved to allow webbing to slide thereon.

17 A webbing tie down assembly as claimed in claim 16, wherein the shaft is cylindrical.

18. A webbing tie down assembly as claimed in claim 15, wherein the supporting surface is provided on the other clamping member for supporting webbing wrapped there around, the supporting surface being configured to prevent undue tension on webbing supported thereby.

19. A webbing tie down assembly as claimed in claim 18, wherein the inner frame comprises a first pair of substantially parallel inner plates, and the outer frame comprises a second pair of substantially parallel outer plates, the assembly further comprising a roller shaft, wherein the first pair of substantially parallel inner plates is mounted on the roller shaft to pivot between the first and second positions, and wherein in the first position, the inner plates of the first frame lie between the outer plates of the second frame, and wherein the supporting surface extends within the boundary of the inner plates in the first position.

20. A webbing tie down assembly as claimed in claim 19, further comprising a latching mechanism, for securing the inner plates with respect to the outer plates in the first position.

21. A webbing tie down assembly as claimed in claim 20, wherein the first pair of substantially parallel inner plates are linked together by a handle for movement between the first and second positions.

22 A webbing tie down assembly as claimed in claim 20, in which the tensioning mechanism includes a pair of slots in respective ones of either the first pair of substantially parallel inner plates or the second pair of substantially parallel outer plates, the roller shaft extending through the pair of slots and being rigidly mounted to the other of the first pair of substantially parallel inner plates or the second pair of substantially parallel outer plates, so that the first frame can be displaced relative to the second frame along the length of the slots.

23. A webbing tie down assembly as claimed in claim 22, in which the slots are curved.

24. A webbing tie down assembly as claimed in claim 22, in which the roller shaft forms one of the first and second clamping members and the other of the first and second clamping members is rigidly secured between the parallel plates of the frame carrying the slots.

25. A webbing tie down assembly as claimed in claim 14, in which the assembly has a first end and a second end, the first end carrying a hook mounted to the first or second frame for attachment to an object to be tied down, the hook secured to the first or second frame at a pair of securing points.

26. A webbing tie down assembly as claimed in claim 25, in which webbing enters and exits the assembly at the second end thereof, the webbing being wrapped around at least one supporting surface and between the clamping surfaces of the first and second clamping members.

27. A webbing tie down assembly as claimed in claim 26 in which the at least one supporting surface includes one or more pulley shafts arranged within the assembly to distribute the load of the webbing whilst spacing apart the surfaces thereof.

28. A webbing tie down assembly as claimed in claim 26, in which the supporting surface adjacent the second end of the assembly has a minimum radius of curvature of 6.35 mm.

29. A webbing tie down assembly, comprising:
an inner frame supporting a first clamping member having a first clamping surface, and an outer frame supporting a second clamping member having a second clamping surface, the inner frame and the outer frame being arranged to support webbing therein, the inner frame being mounted with respect to the outer frame for movement between a first position in which the first and second clamping surfaces are substantially together for clamping webbing therebetween, and a second position in which the clamping surfaces are apart for allowing webbing to slide there through;
wherein the first and second clamping surfaces are configured to provide substantially parallel surfaces in said first position so that a clamping force on the webbing is distributed over a relatively large surface area of the webbing;
characterized in that a cylindrical shaft forms one of the first and second clamping members whereby a part of the surface thereof provides the corresponding clamping surface, and the clamping surface of the other clamping member has a complementary curvature, so that the curved clamping surfaces of the first and second clamping members lie substantially parallel in the first position, and successive parts of the outer surface of the first clamping member smoothly merge into one another without any abrupt change of direction so that the webbing is not distorted.
